(19) United States
(12) Patent Application Publication
(10) Pub. No.: US 2010/0011933 A1
(43) Pub. Date: Jan. 21, 2010

(54) SAW BLADE INSERT AND METHOD AND MEANS OF SHARPENING SAME

(76) Inventor: Rex Cameron Lucas, Victoria (AU)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/303,093

(22) PCT Filed: May 31, 2007
(86) PCT No.: PCT/AU07/00760

§ 371 Date: Jun. 12, 2009

(30) Foreign Application Priority Data
Jun. 1, 2006 (AU) 2006902998

(51) Int. Cl. B27B 33/12; B23D 61/06; B23D 63/14

(52) U.S. Cl. 83/835; 83/839; 76/112; 76/40

(57) ABSTRACT

A saw blade insert (12) comprises a body (12′) of hard material. The body (12′) is fixable to an edge of a gullet of a saw blade. The insert (12) has a concave surface profile (23) which, in use, is forward facing relative to the cutting direction of the saw blade. The profile (23) can be curved or angular such as a shallow “U” shape with flat surfaces (43) which extend inwardly from sides (22) to a central longitudinal floor (44).

### BACKGROUND TO THE INVENTION

This invention relates to a saw blade insert and method and means of sharpening or dressing same.

It is well known in the art of sawing to apply a hard material (e.g. steelite tungsten) insert to the tip of a saw tooth. The saw tooth can be on a circular saw blade or a band saw. The purpose of the tip is to provide a hard, long lasting tip, which results in increased intervals between sharpening of the blade.

In the art of sawmilling there are a number of criteria, which have an impact of the effectiveness and the efficiency of a saw milling operation. These include:—
Width of the kerf
Cutting speed
Accuracy of the cut
Finish of the cut surface(s)
Ease of sharpening of the saw
Ease of saw maintenance (e.g. retipping of the saw).

Factors impacting on the foregoing can be many and complex. For example, one factor is the ability of the tips of the saw to cut effectively and to retain a good cutting performance for as long as possible between sharpenings. Another is the ability to clear, during the sawing operation, chips, sawdust and the like debris from the cut and prevent build up to one or both sides of that part of the saw in the cut.

Stability of the saw blade during the sawing operation is another factor. A saw blade which is unstable or becomes unstable during sawing can adversely impact on accuracy and finish. In the strive to achieve a thinner kerf (which increases recovery or production of sawn timber from a log) the blade necessarily is of thinner section, but this can result in a greater possibility of saw instability.

The importance of maintaining saw tips in good condition by regular and correct sharpening also cannot be overlooked. The saw can be sharpened while on the sawing apparatus or can require dismounting so as to aid the sharpening process. Either way, there is a consequential loss in production time. Therefore, a natural tendency is to use a saw longer than is ideal. The resultant poor cutting performance impacts of cutting speed, accuracy and finish.

### SUMMARY OF THE INVENTION

With the foregoing and other factors in mind, my objective has been to come up with innovations in the saw tip design, saw design and sharpening of saw tips.

To this end, I have devised a saw blade insert which broadly can be said to include a body of hard material adapted to be fixable to an edge of a gullet of a saw blade, the hard material tip having a concave surface which in use is forward facing relative to the cutting direction of the saw blade.

In one form of the invention the concave surface is of curved cross-section.

In a second form of the invention the concave surface is of angular cross-section. The angular cross-section can be substantially “U” shaped or substantially “V” shape. The “U” or “V” shape can be of shallow configuration.

In a preferred form of the Invention the forward facing surface of the insert is of curved profile. The curvature of profile is preferably arcuate with the radius of curvature substantially that of a sharpening wheel.

I have also devised a saw blade, which can be broadly defined as including a plurality of inserts as defined in the first broad aspect stated above.

Preferably the saw blade is a circular saw blade. In a preferred form of the invention when in the form of a circular saw blade, the saw blade includes a plurality of sweep openings, each having a sharpenable hard material insert.

In one form of the invention the, or some of the sweep openings are located at the peripheral edge of the saw blade.

The sweep openings can be open to the peripheral edge of the saw blade.

Furthermore, in a effort to provide for ease of sharpening of saw blade inserts and to enable the sharpening to be carried without the need to be highly skilled, I have devised a method of sharpening which can be broadly said to include the steps of locating a sharpening tool with a location point of the surface of the saw blade, introducing a rotatably sharpening wheel at least partially into a gullet or sweep opening in the saw blade and moving the sharpening wheel relative to a hard material insert associated with the gullet to at least partly sharpen the insert.

The aforesaid object of providing for ease of sharpening has also lead to the innovation of a sharpening tool for sharpening a saw blade insert, the tool broadly being defined as including a base, a locating means for locating the base with a location point on a saw blade, a motor driven sharpening wheel carried by a mounting means, the mounting means being moveable whereby the sharpening wheel can be moved relative to the base.

### BRIEF DESCRIPTION OF THE DRAWINGS

The foregoing innovations will hereinafter be described in more detail and reference will be made to the accompanying drawings in which:—

FIG. 1 is a partial view of a circular saw blade incorporating saw inserts according to one form of the invention,

FIG. 2 is a perspective and somewhat schematic illustration of a sharpening tool,

FIG. 3 is a partial elevation view of the tool of FIG. 2 in conjunction with a circular saw blade,

FIG. 4 is a more detailed illustration of one embodiment of the insert for the saw blade as shown in FIG. 1,

FIG. 5 is a cross-section through the insert of FIG. 4,

FIG. 6 is a partial elevation view of a blade according to the present invention but in a further form,

FIG. 7 is a plan view of the blade as show in FIG. 6,

FIG. 8 is a cross section detail through the tip insert on line A-A of FIG. 7,

FIG. 9 is an isometric view of a further embodiment of the saw insert,

FIG. 10 is a plan view of the saw insert of FIG. 9,

FIG. 11 is a side elevation of the saw insert of FIG. 9, and

FIG. 12 is an end elevation of the saw insert of FIG. 9.

### DETAILED DESCRIPTION OF PREFERRED EMBODIMENTS OF THE INVENTION

In the following more detailed description reference will be made to a circular saw blade. This is by way of example. My inventions can equally be applicable to other saws and more particularly a band saw.

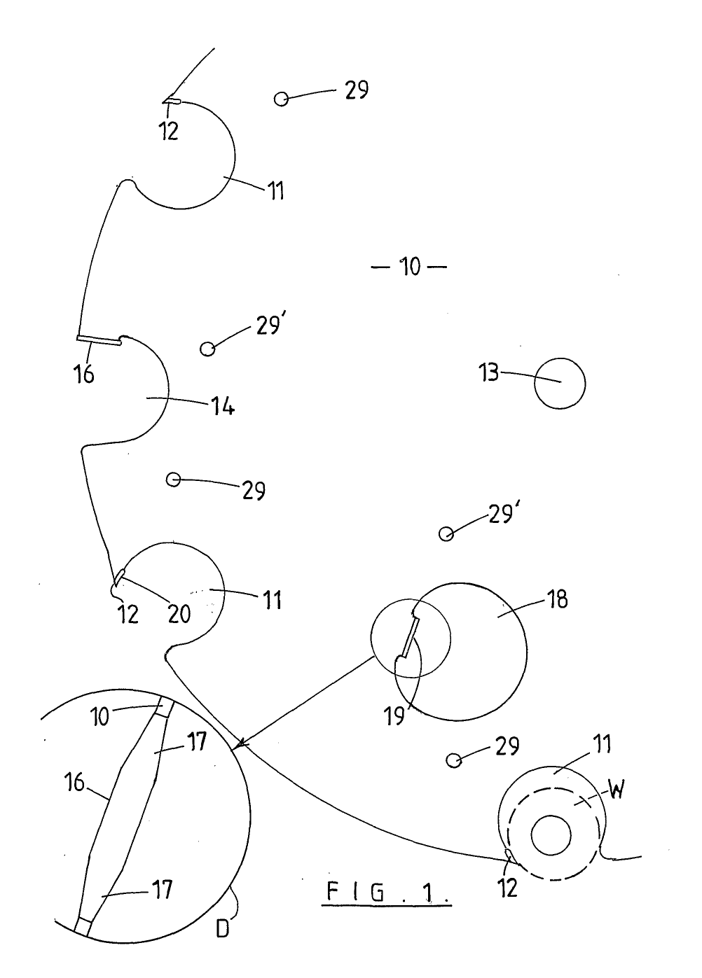

As shown in FIG. 1, the circular saw blade 10 is provided at spaced intervals about its periphery with gullets 11, each of which has an insert 12 of a hard material such as steelite tungsten. As is shown in FIG. 1, each of the gullets 11 is of a generally part circular configuration.

As is conventional, the blade 10 incorporates a central bore 13 to facilitate mounting of the blade in sawing apparatus such as a sawmill. In this regard, my blade 10 is principally intended for use in circular saw sawmills. I envisage the blade as being particularly useful for use with portable sawmills. However, smaller dimensioned blades are also envisaged as will hereinafter be described.

According to my invention, I also propose the incorporation of a plurality of sharpenable sweeps In the saw blade 10. As Illustrated, sweeps 14 can be positioned at or adjacent the peripheral edge of the blade at regular intervals. As is illustrated in FIG. 1, the sweep 14 can be open to the periphery of the blade, but this is by way of example. I envisage that sweep 14 could be fully enclosed, but nevertheless located adjacent the peripheral edge of the blade.

As mentioned above, the sweep 14 is of a sharpenable nature. Therefore within the aperture there is mounted a hard material sharpenable insert 16, which faces in the direction of rotation of the blade 10.

According to a preferred form of the invention, the sweep insert 16 has a profile (when viewed toward the leading face surface) as shown in enlarged scale in detail “D” of FIG. 1. As shown, the sweep insert 16 has a central width greater than the thickness of the blade 10, but tapers toward an end 17, which is approximately the thickness of the blade. This insert 16 is sharpenable in the same manner and by the same tool as herein described with regard to saw tip insert 12.

According to a preferred form of the invention, the blade 10 can include one or more internal sweeps 18, each of which is generally circular in shape. Each sweep 18 incorporates an insert 19 of the same or similar profile as shown in detail D. The insert 19 faces in the direction of rotation of the blade 10.

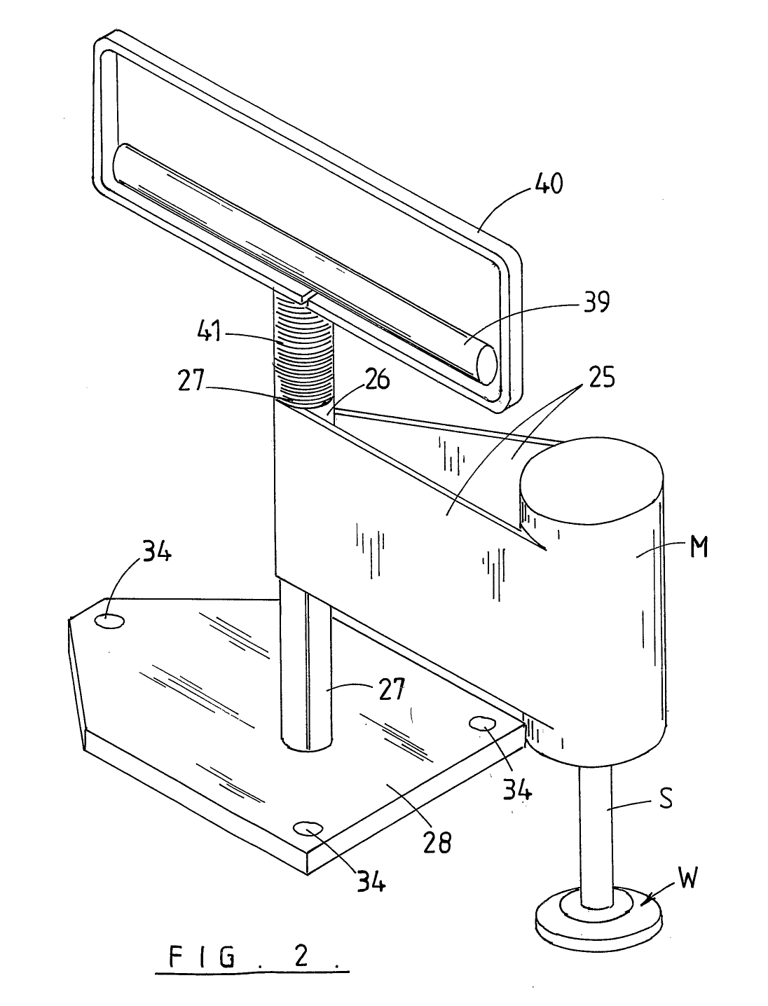

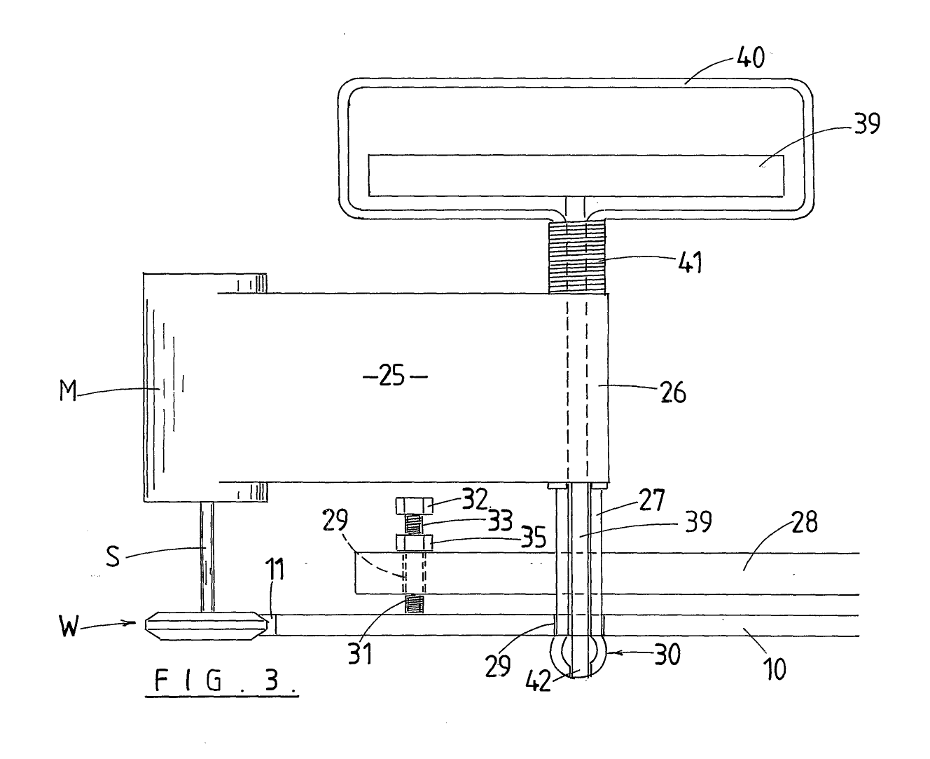

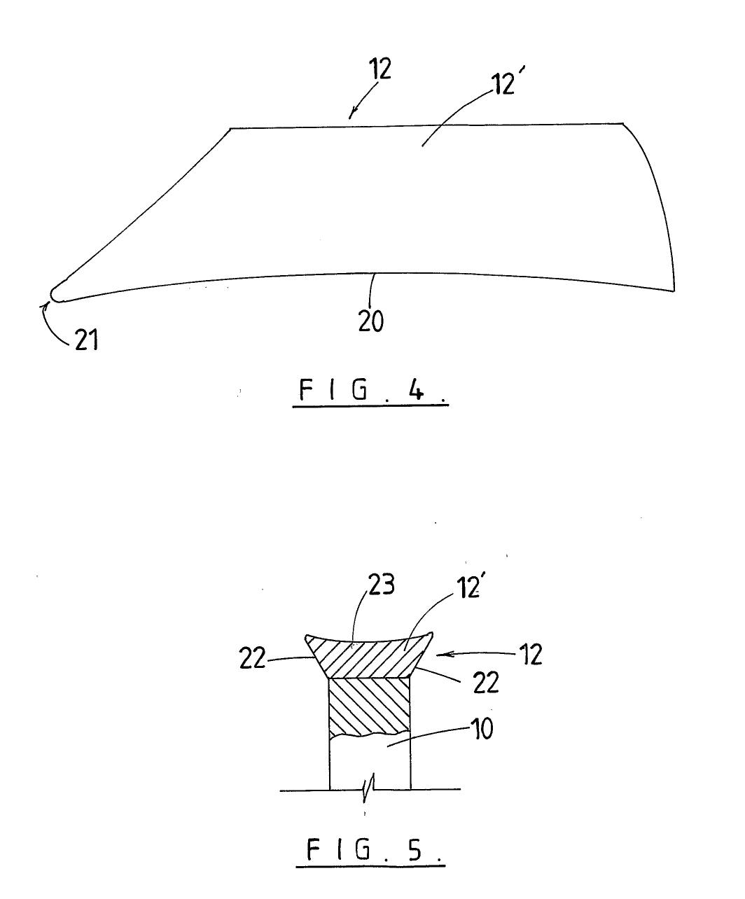

Referring now to FIG. 4 of the drawings, the tip insert 12 (which is shown in enlarged scale) comprises a body 12′ which, in this form and when viewed side on, presents a curved or arcuate profile 20. In the preferred form of the insert 12, according to this form of the invention, the radius of the curved profile 20 is that, or substantially that, of a sharpening wheel W (see FIG. 3) of the sharpening tool, which will hereinafter be described.

In a preferred form of the invention, the extreme point 21 of the tip 12 can be chamfered in the interests of longevity. The chamfering of the point 21 reduces the possibility of fracture of the leading point, and improves the cut finish.

Referring to FIG. 5, this form of the tip insert 12 when viewed in cross-section has side surfaces 22 which diverge from the root end of the tip (where the tip body 12′ is joined to the blade) to the distal end of the tip 12. As a result, the width of the tip insert 12 at its distal or leading edge (relative to the direction of rotation) is wider than the root end and therefore wider than the thickness of the blade 10.

In addition, the tip 12 preferably presents a concave profile 23. This profile can either be curved or angular. In FIG. 5, the concave profile 23 is shown to be of a shallow curve, but in other embodiments the profile could be of a less radius (and therefore deeper) or could be of U or V shaped profile. A V shaped profile of another embodiment of the saw insert 12 is shown in FIG. 8.

The sharpening wheel W therefore has a peripheral edge profile, which substantially conforms with the configuration of the profile 23 of the tip 12. Thus, for say a V shaped profiled surface 23, the peripheral edge surface of the sharpening wheel W will be of V shape. As shown in FIG. 3, the wheel W has an angular profile that will form or sharpen a corresponding profile of surface 23 of the insert 12.

As shown in FIG. 1, the preferred form of the invention provides a gullet 11 which is of sufficient dimensions to accommodate therewithin the sharpening wheel W.

However, with smaller blades 10, it might not be possible to provide a gullet which is of sufficient dimensions to fully accept the dimensions of the wheel W. In such situations, the wheel will be profiled on its peripheral edge so that the wheel W can be tilted (relative to the face surface of the blade 10) such that the edge of the sharpening wheel W can locate in the gullet and engage with the tip 12 and sharpen one part of surface 23 or the entirety of surface 23. However, it is believed that in such an arrangement, the tilted wheel W will be introduced into the gullet 11 from one side of the blade 10 to part-sharpen the surface 23 and then moved to the other side of the blade tilted and introduced into the gullet to sharpen the other part of the surface 23.

The sharpenable sweep inserts 16 and 19 will also be sharpenable using the sharpening wheel W. Because these inserts are flat rather than curved in profile, the aforementioned profile of detail D is employed such that a sharpening effect over the entire facing surface of the insert 19 is achieved by the circular sharpening wheel W.

Referring now to FIG. 2, there is shown a sharpening tool which comprises an electric (battery) powered motor M to the output shaft S of which is mounted the profiled grinding wheel W. The motor M is mounted by arms 25 which project from a sleeve-like mount (or similar) 26 which is rotatably located on a pivot shaft 27 which extends through a base plate 28. The projecting end 30 of the pivot shaft 27 is engageable in a datum or locating hole 29 which is formed in the blade 10 in an appropriate position adjacent the gullet 11.

The plate 28 is also provided with three pointed pins 31 which project from the same side of the plate 28 as the distal end 30 of the pivot shaft 27 (see FIG. 3). In the preferred form of the invention, each of pins 31 is provided with a head 32 (preferably of hexagonal profile) with at least part of the length of the pin being threaded 33 and engaged in a corresponding threaded bore 34 in the plate 28. A lock nut 35 is located between the plate 28 and the head 32. The pin 31 can thus be rotated, via head 32, so as to adjust the distance, the pointed end 36 projects from the base plate 28. It can then be locked in place via the action of lock nut 35.

The pins 31 can therefore be used for the dual purposes of spacing the base plate 28 at a desired distance from the blade 10 (for reasons which will hereinafter become apparent). They also ensure that the plate 28 can be positioned such that the pivot shaft 27 is correctly orientated to ensure that when the peripheral edge of the grinding wheel W is brought into contact with the tip insert 12, it is in a manner which will ensure correct reprofiling of the surface of the tip insert 12.

Referring more particularly to FIG. 3, a preferred form of attachment of the pivot shaft 27 to the blade 10 is shown. As illustrated, the pivot shaft 27 is hollow and the distal end 30 is of bulbous form. Located within the hollow shaft 27 is a sliding shaft 38 which has a handle 39. This handle 39 is preferably located within the confines of an outer handle 40 which is fixed to the pivot shaft 27. A spring 41 biases the sliding shaft 39 so that the distal end 42 of the sliding shaft 39 is engaged within the confines of the bulbous end 30 of the pivot shaft 27.

The bulbous end 30 of the pivot shaft 27 is provided a plurality of longitudinal splits (not shown) in the wall so that the bulbous distal end 30 is deformable. Consequently, in use, the operator will manipulate the tool so that the bulbous end 30 is aligned with the datum opening 29 in the blade 10. The handle 39 will then be lifted against the bias of spring 41 so that the bulbous end 30 can be forced through the datum hole 29. Once through the hole 29, the handle 39 can be released which will cause the handle to retract to its rest position whereupon the sliding shaft 39 will apply a force to the bulbous end 30. This results in the bulbous end having a cross-sectional dimension greater, than that of the hole.

In such position, the pointed ends 36 of the pins 31 will be in contact with the surface of the blade 10 and hence the tool T will be located in a stable fashion on the blade with the grinding wheel W located within the gullet 11. With the motor operating, the operator can then move the motor toward and away from the tip 12 (about the axis of pivot shaft 27) and thereby carry out the sharpening/dressing operation. When completed, the handle 31 can be raised thereby enabling the bulbous end 30 to compact and be extracted from the datum opening 29. The tool can then be moved to the next datum opening 29 for sharpening/dressing of the tip insert in the corresponding gullet 11 to be carried out.

It will be appreciated by those skilled- in the art that the datum or reference hole 29 is located in a position whereby the correct positional relationship between the grinding wheel W and the profile of the tip insert 12 is achieved. Thus, the datum or reference hole 29 can be located on a chord line of the profiled surface 20 of the tip insert 12 or offset to the chord line depending on the geometry of the component parts of the tool and the blade.

In a similar manner, each sweep 14, 18 will also be provided with a datum or reference hole 29′ whereby the tool can also be used to sharpen/dress the face of the sweep insert.

The invention is open to modification as will he appreciated by those skilled in the art. For example, adaptations and improvements can be made to the profiles of the tip insert and/or sweep insert. For example, it is envisaged that the curved profile 20 of the tip insert could be straightened. The sharpening wheel W would thus then need to be mounted by a tool which provided rectilinear movement of the wheel W relative to the reference or datum hole 29 as opposed to the radial movement of the wheel W relative to the reference hole 29 as hereinbefore described.

Also, the amount by which the side edges of the tip insert 12 can diverge to the distal edge can be altered. Such a change could alter the aggressiveness of the tip, which may be useful depending on the types of timber to be sawn.

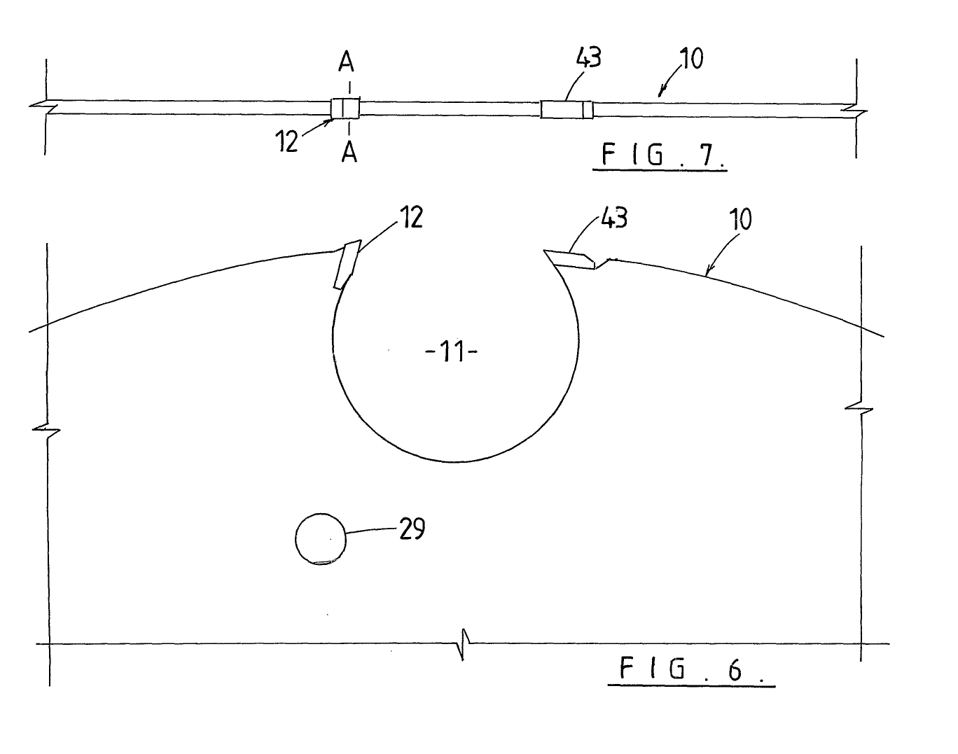

Thus, for example in FIG. 8 the profile of the tip insert 12 is shown to be of generally V shape. Also the sides 22a of the insert 12 can be slightly off parallel to be slight divergent rather than divergent from the root end of the tip in the manner shown in FIG. 5. The width of the tip insert 12, however, is slightly wider than the thickness of the blade as is apparent from FIG. 6. As indicated in FIG. 8 the angle of the side of the profile 23 of the tip insert 12 is, relative to the axis of the blade, 140°. The included angle of the V shaped profile is therefore substantially 100°.

Irrespective of the profile of the tip insert, it is the intention that the tip cut rather than tear through the timber. It is believed that this will stop tear-out around knots and will generally provide a better finish.

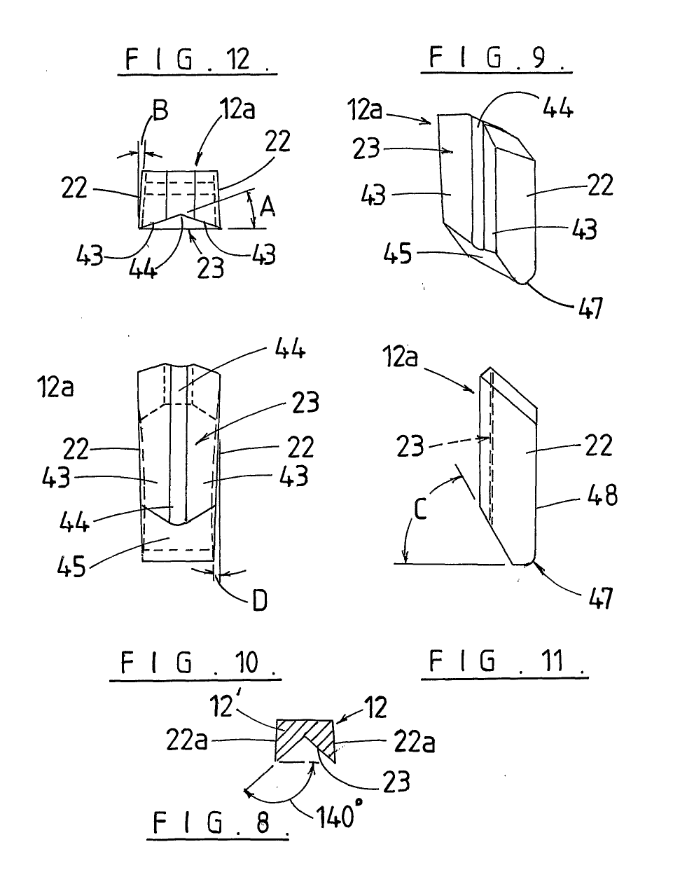

A further form of the tip/insert 12a is shown in FIGS. 9-12. This form has a shallow substantially V shaped surface profile 23. This comprises substantially flat surfaces 43 which extend inwardly from the sides 22 to a centrally located bottom 44 which can be flat or, as illustrated (see FIGS. 10 and 12), can be curved (e.g. a radius of R.060). In the illustrated embodiment the angle A (see FIG. 12) is about 20°.

As previously disclosed the sides 22 taper inwardly as shown in FIG. 12, the angle of taper B can be about 2°.

The leading surface 45 of the tip/insert 12a inclines forwardly from the surface profile 23 as can be best seen In FIG. 1. The angle C shown in FIG. 11 is substantially 60°. As shown in FIG. 10 the sides 22 also taper back from the leading end 46 at an angle D of about 1.5°. The leading end 46 preferably has a curved transition 47 to the underside 48 of the tip/insert 12a.

The included angle between surfaces 43 is, in the illustrated form of tip/insert 12a, substantially 140°. This included angle can lie within the range of 120°-160°.

The side of the tip/insert 12a is sharp thus leading to a cutting action rather than a tearing action. The tip is wider than the thickness of the blade as is conventional with cutting tips, however, while it is normal for the tip to be wider on each side of the blade by about 0.006 the present tip/insert 12a is only wider each side by about 0.0035.

In the preferred form of the tip/insert 12a it is of a cast form.

The sweeps 14 and/or 18 are particularly useful for hard woods, which tend to produce short grain chips, which spill out of the gullet and produce friction between the saw and timber. It is believed that the sweeps according to the present invention will reduce the production of such short grain chips and therefore generally result in good clean out of the kerf, thereby leading to better stability characteristics of the saw.

According to a further embodiment of the invention the sweeps 14 could be omitted.

As shown in FIGS. 6 and 7 a further form of the blade 10 includes a further insert or tip which, once again, can be of tungsten material. This tooth 43 is positioned at the leading edge of the gullet 11 and acts as a guide for the cutting tooth or insert 12 to follow. The additional tooth 43 enters the timber before the cutting tooth 12 and forces the tip to stay in line.

It will be apparent to those skilled in the art that modifications can also be made to the sharpening tool. For example, rather than employing the deformable bulbous end 30 the end 30 could incorporate a plate pivotally engaged with the end 30 so as to be movable from a position aligned and within the confines of the external diameter of the pivot shaft 27 and one where it extends transverse to the longitudinal axis of the pivot shaft 27. Thus, when in the aligned configuration, the end 30 of the pivot shaft 27 can be engaged in the datum or locating hole 29 whereupon the plate can be moved to its transverse position (where it projects diametrically from opposite sides of the pivot shaft 27). These pivot shafts 27 can thus be moved by a suitable manipulator or handle into a position where the diametrically projecting plate engages with the surface of the blade opposite to that with which the pins 31 engage.

It will be appreciated by those skilled in the art that other means of releasably engaging the pivot shaft 27 with the blade 10 can be employed.

Other modifications to the blade and/or sharpening tool will be apparent to those skilled in the art and fall within the scope of the present invention.

1. A saw blade insert which includes a body of hard material adapted to be fixable to an edge of a gullet of a saw blade, the hard material tip having a concave surface which, in use, is forward facing relative to the cutting direction of the saw blade.

2. The insert of claim 1 wherein the concave surface is of curved cross-section.

3. The insert of claim 1 wherein the concave surface is of angular cross-section of a substantially “U” shape or substantially “V” shape in a shallow configuration.

4. The insert of claim 3 wherein the included angle of the angular cross-section lies in the range of substantially 120° to 160°.

5. The insert of claim 4 wherein the included angle is substantially 140°.

6. The insert of claim 4 or 5 wherein the angular cross-section is formed by flat surfaces that incline inwardly from opposite sides of the body and meet in a flat or curved floor.

7. The insert of any one of claims 1 to 6 wherein the forward facing surface of the insert is of curved profile.

8. The insert of claim 6 wherein the curvature of profile is arcuate and substantially the radius of curvature of a sharpening wheel.

9. A saw blade which includes a plurality of inserts as claimed in any one of claims 1 to

10. The saw blade of claim 9 wherein the gullet is curved.

11. The saw blade of claim 9 wherein the gullet is of a generally part circular configuration.

12. The saw blade of claim 9, 10 or 11 wherein the saw blade is in the form of a circular saw blade.

13. The saw blade of any one of claims 9 to 12 wherein it includes a plurality of sweep openings, each having a sharpenable hard material insert.

14. The saw blade of claim 13 wherein the, or some of the sweep openings are located at the peripheral edge of the saw blade.

15. The saw blade of claim 13 wherein the sweep openings open to the peripheral edge of the saw blade.

16. A method of sharpening a saw blade which includes the steps of locating a sharpening tool with a location point of the surface of the saw blade, introducing a rotatably sharpening wheel at least partially into a gullet or sweep opening in the saw blade and moving the sharpening wheel relative to a hard material insert associated with the gullet to at least partly sharpen the insert.

17. The method of claim 16 wherein the saw blade is as claimed in any one of claims 1 to 15.

18. A sharpening tool for sharpening a saw blade insert the sharpening tool including a base, a locating means for locating the base with a location point on a saw blade, a motor driven sharpening wheel carried by a mounting means, the mounting means being moveable whereby the sharpening wheel can be moved relative to the base.

19. The tool of claim 18 wherein the locating means is a pivot shaft which has a distal end engageable in a location point of a saw blade, the location point being an opening in the saw blade, the distal end including means which captures the distal end in a location point.

20. The tool of claim 19 wherein the base includes a plurality of pointed elements which project to a side of the base from which the distal end of the pivot shaft projects.

21. The tool of any one of claims 18 to 21 wherein the mounting means is pivotally coupled to the pivot shaft and mounts an output shaft of the motor, to which the sharpening wheel is coupled, a distance from the base.

22. The tool of claim 20 wherein the distance between the pointed end of the pointed pins and the base is adjustable.

23. A saw blade insert substantially as herein described with reference to the accompanying drawings.

24. A saw blade insert substantially as herein described with reference to FIGS. 9 to 12 of the accompanying drawings.

25. A saw blade substantially as herein described with reference to the accompanying drawings.

26. A saw blade sharpening tool substantially as herein described with reference to FIGS. 2 and 3 of the accompanying drawings.
